(19) United States
(12) Patent Application Publication
(10) Pub. No.: US 2015/0073652 A1
(43) Pub. Date: Mar. 12, 2015

(54) ENERGY CONSUMPTION OPTIMIZATION SYSTEM

(71) Applicant: FORD GLOBAL TECHNOLOGIES, LLC, Dearborn, MI (US)

(72) Inventors: Brian Bennie, Sterling Heights, MI (US); Cynthia M. Neubecker, Westland, MI (US)

(73) Assignee: FORD GLOBAL TECHNOLOGIES, LLC, Dearborn, MI (US)

(21) Appl. No.: 14/023,749

(22) Filed: Sep. 11, 2013

(51) Int. Cl. B60W 50/00

(52) U.S. Cl. CPC B60W 50/00
USPC 701/36

(57) ABSTRACT

A vehicle energy consumption optimization system may include a controller configured to detect a trigger event to determine a passenger departure. The controller may receive at least a first and second sensor input to determine a vacancy zone in response to the trigger event, associate a feature usage with the vacancy zone, and deactivate the feature usage associated with the vacancy zone.

### BACKGROUND

Vehicles are equipped with many systems to enhance the driving experience. As original equipment manufacturers (OEM) strive to provide high standards of comfort and luxury, systems within the vehicle cabin compartment are becoming more complex and abundant. For example, a typical vehicle may include heated and cooled seats, massage seats, independent climate zones, and televisions and DVD players. However, all these systems consume energy and are directly related to fuel economy and energy consumption. Although fuel economy and energy consumption are important for all vehicles, manufacturers are particularly sensitive to these parameters for hybrid and/or electric vehicles.

A particular problem of wasteful energy consumption occurs along a vehicle route, when individuals enter, activate a feature, and then exit the cabin compartment leaving the feature “ON.” The feature may thus be left activated until the feature times out or until the vehicle is turned off. Likewise, features may be left inadvertently activated when they are not needed, e.g., for vacant seats or rear seats that contain a child's car seat. Accordingly, there is a need to monitor when individuals egress the vehicle to re-adjust the feature settings.

### SUMMARY

A vehicle energy consumption optimization system may include a controller configured to detect a trigger event to determine a passenger departure. The controller may receive at least a first and second sensor input to determine a vacancy zone in response to the trigger event, associate a feature usage with the vacancy zone, and deactivate the feature usage associated with the vacancy zone.

A vehicle controller configured to detect the egression of an occupant may include a module configured to detect a trigger event to determine a passenger departure and receive at least a first and second sensor input to generate a vacancy zone output in response to the trigger event. The controller may also include a processor configured to receive the vacancy zone output from the module, associate the vacancy zone output with a feature usage, and deactivate the feature usage associated with the vacancy zone.

A method to detect the egression of an occupant to optimize energy consumption may include monitoring, via a computing device, vehicle occupancy based on at least a first and second sensor input in response to detecting a trigger event; determining a vacancy zone in response to the sensor input; associating a feature usage with the vacancy zone; and deactivating the feature usage associated with the vacancy zone.

### BRIEF DESCRIPTION OF THE DRAWINGS

FIG. 1 is a schematic representation of normal energy usage for a vehicle with a driver and six passenger seats;

FIG. 2 illustrates an exemplary vehicle energy consumption optimization system; and

FIG. 3 is an exemplary process to optimize vehicle energy consumption in the cabin compartment based on vehicle occupancy and feature usage.

### DETAILED DESCRIPTION

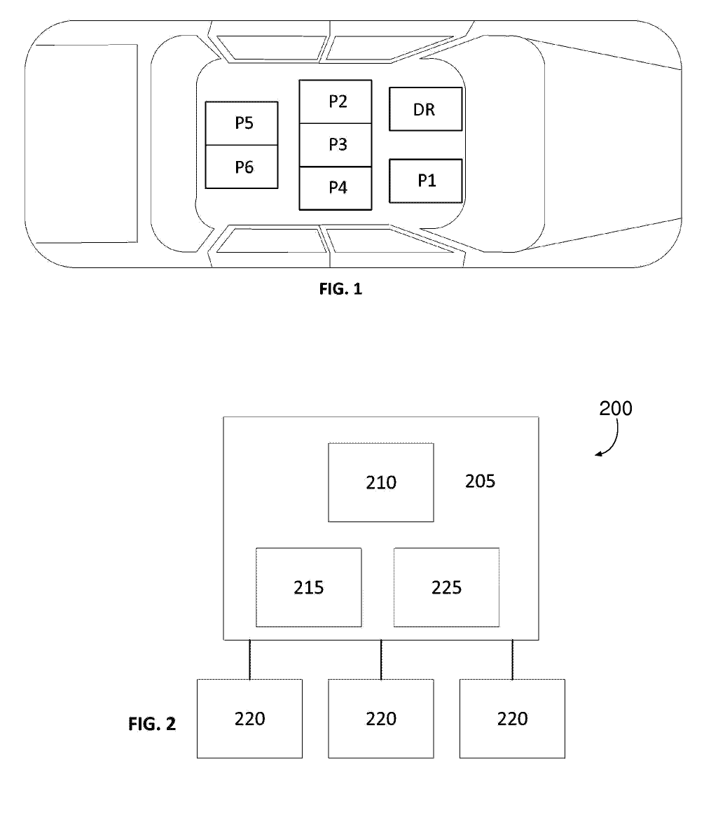

FIG. 1 is a schematic representation of normal energy usage for a vehicle with six passenger seats. The accumulation of energy consumed by the usage of a vehicle feature (e.g., massage seat or interior cabin lights) may have a significant impact on fuel economy. For example, if the driver (DR) and first passenger (P1) use heated and massage seats, the energy consumption may equal about 10 A per seat. Further, if the rear passengers 2-6 (P2-P6, respectively), use heated seats and rear climate control on high blower, the energy consumption may equal roughly 4 A per seat and 10 A for climate control for a total of 50 A consumed.

However, during the normal course of driving, passengers may exit the vehicle without turning off the seats respective feature, such as the heated and massage seat or the climate control. For example, if P1-P6 exit the vehicle without turning off the seats respective feature and rear climate, the result is a waste of roughly 40 A. Consequently, the vehicle may experience reduced fuel economy due to the features inadvertent activation. The energy consumption optimization system 200 disclosed herein monitors the vehicle to determine the most optimum performance without waiting for a feature time out routine or a key cycle off

FIG. 2 illustrates an exemplary vehicle energy consumption optimization system 200. The system may take many different forms and include multiple and/or alternate components. While an exemplary system is shown in the Figures, the exemplary components illustrated in the Figures are not intended to be limiting. Indeed, additional or alternative components and/or implementations may be used.

FIG. 2 illustrates a diagram of the vehicle energy consumption optimization system 200. While the present embodiment may be used in an automobile, the system 200 may also be used in any vehicle, including, but not limited to, motorbikes, boats, planes, helicopters, and off-road vehicles.

The system 200 may include a controller 205. The controller 205 may include any computing device configured to execute computer-readable instructions. For example, the controller may include a processor 210 and a module 215. The processor 210 may be integrated with, or separate from, the controller 205. Additionally or alternatively, there may be multiple controllers 205, each including a processor 210 and a module 215.

In general, computing systems and/or devices, such as the controller 205 and processor 210, may employ any number of computer operating systems, including, but not limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating system distributed by Apple, Inc. of Cupertino, Calif., the Blackberry OS distributed by Research in Motion of Waterloo, Canada, and the Andriod operating system developed by the Open Handset Alliance. It will be apparent to those skilled in the art from the disclosure that the precise hardware and software of the controller 205 and processor 210 may be any combination sufficient to carry out the functions of the embodiments discussed herein.

The controller 205 may be configured to control the availability of feature usage in the vehicle through the processor 210. Feature usage, for example, may include, but is by no means limited to, a system for climate control or a heating, ventilation, and air conditioning (HVAC) system, television and DVD players, foot well LED lights, reading light, seat massage, and seat heating and cooling. One skilled in the art will understand from the disclosure that the particular feature may include any feature controlling a system or subsystem in the vehicle. The feature usage may be specific to a particular seat, broad to a row of seats, or may apply generally to the front or rear passenger compartments.

The controller 205 may be configured to detect a trigger event and monitor vacancy zones. The trigger event may be any input indicating a passenger has exited or egressed from the vehicle. For example, the trigger event may be an indication that a passenger door is ajar. The vacancy zone may be an indication that a previously occupied seat is now vacant. Likewise, the vacancy zone may represent a row of vacant seats, whether previously occupied or not.

The controller 205, via the processor 210, may be configured to detect the trigger event and monitor vehicle vacancy zones through sensors 220. Alternatively, the sensors 220 may communicate the trigger event and vacancy zones to a module 215, which in turn communicates the sensor 220 input to the processor 210. The processor 210 may be configured to execute one or more processes for controlling and monitoring the feature usage, trigger event, and vacancy zones. Additionally or alternatively, the controller 205 may include various modules 215, each configured to communicate with the processor 210 via a gateway module 215. The module 215 and sensors 220 may be in communication with the controller 205 via an interface (not shown). The interfaces may include an input/output system configured to transmit and receive data from the respective components. The interface may be one-directional such that data may only be transmitted in one-direction. Alternatively, the interface may be bi-directional, both receiving and transmitting data between the components.

The sensor 220 may include any sensor or sensor system available in the vehicle that may be used to detect the presence of an occupant. For example, the sensor 220 may embody an ultrasonic sensor, occupant classification system (OCS), seat belt monitoring sensor, door ajar sensor, interior imaging camera, infrared sensors, Global Positioning System (GPS), velocity sensor, and brake sensors. However, it will be apparent to those skilled in the art from the disclosure that the precise sensor 220 may be any sensor 220 configured to monitor the presence of occupants within the vehicle. The sensors 220 may work separate from, or in conjunction with, other sensors 220 on the vehicle. For example, the controller 205 may receive a door ajar sensor 220 input indicating the trigger event (e.g., the exiting of a passenger). Additionally or alternatively, the controller 205 may receive multiple sensor 220 inputs. For example, the controller 205 may use sensor 220 inputs from the ultrasonic sensor and OCS sensor to determine a passenger seat is now vacant. Likewise, the OCS, seat belt monitoring sensor, and interior imaging camera may communicate that the right rear passenger seat is vacant. The controller 205 may associate the vacancy zone with current feature usage.

The controller 205 may control the activation and deactivation of feature usage associated with the vacancy zone. The controller 205 may monitor signals sent from multiple sensors 220 to determine the feature usage associated with an unoccupied seat or row of seats. For instance, the OCS, seat belt monitoring sensor, and interior imaging camera may indicate that the front passenger seat is now unoccupied. The controller 205 may associate a feature usage (e.g., the massage seat is turned on) associated with the vacant front passenger seat and deactivate the feature to optimize energy consumption. Likewise, the controller 205 may recognize the rear floor well light-emitting diode (LED) lights are turned on and deactivate the lights in response to detecting a passenger egress the vehicle.

The controller 205 may be configured to receive various inputs and generate and deliver various outputs in accordance with the inputs received or computer-executable instructions maintained in a database 225. The database 225 may be comprised of a flash memory, RAM, EPROM, EEPROM, hard disk drive, or any other memory type or combination thereof. The database 225 may store predefined alert messages in a long-term memory (e.g., nonvolatile memory) or a Keep Alive Memory (KAM). The alert messages may be associated with each feature usage deactivation and may be predefined by the OEM or customizable by the driver. Likewise, the database 225 may maintain a command associated with each alert message allowing the driver to manually override the feature usage deactivation. For instance, the command may appear on a vehicle display (e.g., a human-machine interface), which may be configured to receive user input to allow or disallow the feature usage deactivation.

Additionally or alternatively, the database 225 may include customizable program options, such as verification event preferences. A verification event may include an indication that reassures the controller 205 to deactivate feature usage. For instance, the verification event may include the vehicle exceeding a threshold speed, detecting the brakes have been disengaged, or a threshold duration of time. The verification event may be pre-programed into the database 225, or may be customized by the vehicle owner.

The vehicle display (not shown) may be in communication with the controller 205 and be configured to present information and options to the users within a vehicle. The vehicle display may include a single type display, or multiple display types (e.g., audio and visual) configured for human-machine interaction. The vehicle display may be configured to receive user inputs from the vehicle occupants. It may include, for example, control buttons and/or control buttons displayed on a touchscreen display which enable the user to enter commands and information for use by the controller 205 to control the various systems of the vehicle. The vehicle display may also include a microphone that enables the user to enter commands or other information vocally.

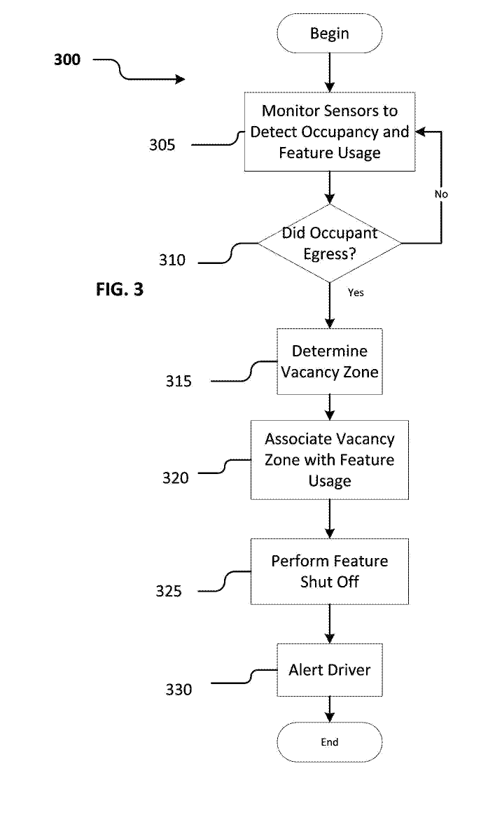

FIG. 3 is an exemplary process 300 to optimize vehicle energy consumption in the cabin compartment based on vehicle occupancy and feature usage. The process 300 may begin at block 305 automatically as the vehicle ignition is already on and the vehicle is moving, for example, on the road or highway. The controller 205 may monitor the sensors 220 to detect vehicle occupancy and feature usage. For example, the controller 205 may communicate with sensors 220 such as the seat OCS, seat belt monitors, and the interior imaging camera to detect that all the seats are filled with passengers. Additionally, the controller 205 may detect current feature usage, such as seat heating/cooling, rear climate control, or DVD player are activated. For instance, the controller 205 may detect the heated and massage seat feature is activated for the front passenger seat.

At block 310, the controller 205 determines whether an occupant egressed from the vehicle. The controller 205 may communicate with the vehicle sensors 220 to detect a trigger event. The trigger event may be, for example, a passenger door ajar, applying the vehicle brakes, the vehicle in park while the engine is running, no change in location, or any combination thereof. The controller 205 may monitor the door ajar sensors 220, the anti-lock brake or TPMS sensors 220, speed sensor 220 and GPS to detect the trigger event. The controller 205 may continually monitor the sensors 220 to detect the trigger event and vacancy zone. In the event no trigger event is detected, the process 300 may return to block 305. If, however, a trigger event is detected by the controller 205, such as communication that a rear passenger door is open and the brakes are applied, then the process 300 may proceed to block 315.

At block 315, the controller 205 may determine a vacancy zone in response to detecting the trigger event. The vacancy zone may include an unoccupied seat or an entire row of empty seats. The controller 205 may monitor signals from various sensors 220 in the cabin compartment to determine which seats remain occupied, if any. Alternatively, the sensors 220 may communicate signals to the module 215 which in turn communicates a vacancy zone output to the processor 210. For instance, the vacancy zone may be determined by monitoring the OCS sensor 220 and seat belt monitoring sensor 220. The OCS may indicate force is not being exerted on the seat and the seat belt monitoring system may communicate the seat belt is unbuckled, thereby detecting a vacant seat. Likewise, the vacancy zone may be determined by monitoring the interior camera sensor 220 or ultrasonic sensor. For example, the pressure sensor 220 in the OCS may indicate a weight is being applied to the seat, but the interior camera sensor 220 may communicate that the weight is merely an empty child car seat. The controller 205 may receive the sensor 220 input from the OCS and interior camera and determine there is a vacancy zone.

At block 320, the controller 205 may determine wasteful feature usage. The controller 205 may associate the feature usage with the vacancy zone. In the event that a passenger seat, previously occupied, is now vacant, the controller 205 may associate the vacancy zone with a feature usage. For example, the controller 205 may detect the rear foot well LED lights are activated and the rear passenger seats are empty. Additionally or alternatively, the controller 205 may determine that the rear seats are vacant and the heated seats are activated. Likewise, the controller 205 may detect the HVAC is on full blower. The controller 205 may determine that the feature usage for the heated seats and HVAC is wasteful in response to the rear seats being vacant. On the other hand, in the event only one previously occupied seat is detected vacant, the controller 205 may only associate the heated seat with the open seat (e.g., the vacancy zone) in that the HVAC may still be in use by the other rear occupants. The process 300 may then proceed to block 325.

At block 325, the controller 205 may perform a feature shut off The controller 205 may deactivate the feature usage associated with the vacancy zone. For instance, in the event the massage seat is activated for a vacancy zone (e.g., an unoccupied seat), the controller 205 may deactivate that feature usage. Additionally, the controller 205 may command the seat feature LED indicator off in response to deactivating the seat feature usage to represent the real system state and avoid consumer confusion. For example, deactivating the heated seat feature may also deactivate the LED indicator located on the seat switch to represent current heated seat system operation. Thus, the process 300 minimizes energy consumption by preforming a feature shut off without waiting for the feature's time out routine or key cycle off The process 300 may further include a feature override in the event the driver or occupant desires the feature usage to continue to run. The controller 205 may detect a user input which may enable the passenger to override the feature usage shutoff For example, a feature seat switch pressed or in the on position may cause the controller 205 to continue running the feature usage, thereby overriding the feature shut off In the event a feature override is detected, the process 300 may return to block 305 and continue monitoring vehicle sensors to detect occupancy and feature usage.

Additionally or alternatively, the controller 205 may standby before deactivating the feature usage until the controller 205 receives a verification event. The verification event may include the vehicle exceeding a threshold speed (e.g., 5 MPH), disengaging the vehicle brakes, or a threshold duration of time (e.g., 30 s). For example, the vehicle speed threshold may be monitored upon detecting a trigger event (e.g., a door ajar event). If the vehicle speed is below target threshold, the controller 205 may standby until the vehicle exceeds the threshold speed. Additionally or alternatively, the verification event may include the controller 205 waiting a predefined duration, such as 30 seconds. For example, the controller 205 may standby before deactivating feature usage for the threshold duration. If the vehicle does not exceed the threshold speed within the threshold duration, the timer may reset and standby for another threshold duration until the vehicle speed exceeds the threshold. Once the verification event is detected, the controller 205 may proceed to deactivate the feature usage.

At block 330, an alert may be communicated to the driver indicating a feature has been deactivated. The alert may be displayed on the vehicle display, broadcast over the vehicle's audio system, or transmitted to a wireless device via Bluetooth® connectivity. Additionally or alternatively, the alert may be accompanied by a command allowing the driver to continue running the feature usage. For instance, the command may be a feature deactivation override allowing the driver to veto the process 300 and allow the rear HVAC system, for example, to continue to run.

Computing devices, such as the controller, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer-readable media associated therewith (e.g., disks, memories, etc.). A computer program product may comprise such instructions stored on computer-readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc. may be interchangeable.

What is claimed as new and desired to be protected by Letters Patent of the United States is:

1. A vehicle energy consumption optimization system comprising:
a controller configured to:
detect a trigger event to determine a passenger departure;
receive at least a first and second sensor input to determine a vacancy zone in response to the trigger event;
associate a feature usage with the vacancy zone; and
deactivate the feature usage associated with the vacancy zone.

2. The system of claim 1, wherein the feature usage is deactivated in response to a verification event.

3. The system of claim 2, wherein the verification event includes exceeding a threshold speed.

4. The system of claim 2, wherein the verification event includes exceeding a threshold duration.

5. The system of claim 1, wherein the trigger event includes a door ajar event.

6. The system of claim 1, wherein the first and second sensor input include one of an occupant classification system sensor, seat belt monitoring sensor, ultrasonic sensor, and interior imaging camera sensor.

7. The system of claim 1, wherein the controller is further configured to transmit an alert of feature usage deactivation.

8. The system of claim 1, wherein the controller is further configured to override the feature usage deactivation in response to a user input.

9. The system of claim 1, wherein the feature usage includes one of a massage seat, heated and cooled seat, climate control, foot well lights, television monitor, and reading light.

10. A vehicle controller configured to detect the egress of an occupant comprising:
a module configured to:
detect a trigger event to determine a passenger departure;
receive at least a first and second sensor input to generate a vacancy zone output in response to the trigger event;
a processor configured to:
receive the vacancy zone output from the module;
associate the vacancy zone output with a feature usage; and
deactivate the feature usage associated with the vacancy zone.

11. The system of claim 10, wherein the first and second sensor include one of an occupant classification system sensor, seat belt monitoring sensor, ultrasonic sensor, and interior imaging camera sensor.

12. The system of claim 10, wherein the feature usage is deactivated in response to detecting a verification event.

13. The system of claim 11, wherein the verification event includes exceeding at least one of a threshold speed and threshold duration.

14. The system of claim 10, wherein the trigger event includes a door ajar event.

15. The system of claim 10, wherein the processor is configured to transmit an alert of feature usage deactivation.

16. A method to detect the egression of an occupant to optimize energy consumption comprising:
monitoring, via a computing device, vehicle occupancy based on at least a first and second sensor input in response to detecting a trigger event;
determining a vacancy zone in response to the sensor input;
associating a feature usage with the vacancy zone; and
deactivating the feature usage associated with the vacancy zone.

17. The method of claim 16, wherein the feature usage is deactivated in response to receiving a verification event.

18. The method of claim 17, wherein the verification event includes one of exceeding a threshold speed and a threshold duration.

19. The method of claim 16, wherein the trigger event includes at least one of a door ajar event and a braking event.

20. The method of claim 16, further comprising communicating an alert message indicating the deactivation of the feature usage.
